(19) United States
(12) Patent Application Publication
(10) Pub. No.: US 2007/0008577 A1
(43) Pub. Date: Jan. 11, 2007

(54) Printing system and printer driver, which are easy to use

(75) Inventors: Tsumoru Matsuura, Toyokawa-shi (JP); Hideki Hino, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/414,339

(22) Filed: May 1, 2006

(30) Foreign Application Priority Data
Jul. 6, 2005 (JP) 2005-196989

(51) Int. Cl. G06F 3/12

(52) U.S. Cl. 358/1.15

(57) ABSTRACT

A printing system has an image forming apparatus and a client terminal, the image forming apparatus executing a print job for image forming that the client terminal has transmitted in accordance with a user's request and transmitting completion information regarding job completion of the print job to the client terminal upon completion of the print job, and the client terminal reporting completion of the print job to the user by means of a notification, upon receiving the completion information from the image forming apparatus, where the client terminal halts any completion reporting when a number of transmitted print jobs to the image forming apparatus does not match a number of completed print jobs counted based on completion information received from the image forming apparatus, and reports, when the number of transmitted print jobs matches the number of completed print jobs, completion of all print jobs whose completion reporting has been halted.

This application is based on application No. 2005-196989 filed in Japan, the content of which is hereby incorporated by reference.

### BACKGROUND OF THE INVENTION

(1) Field of the Invention

The present invention relates to a printing system that includes an image forming apparatus and at least one client terminal, where the image forming apparatus transmits, upon completion of a print job, completion information to a transmission source of the print job, and the client terminal transmits a print job to the image forming apparatus in accordance with a user's request, and upon reception of completion information of the transmitted print job, reports the job completion to the user. The present invention further relates to a printer driver included in the client terminal. The present invention particularly relates to a technology for improving the usability for the user.

(2) Related Art

Recently, image forming apparatuses (e.g. a multiple function peripheral (MFP) and a printer) equipped with many functions and having fast processing speed are on sale. Such image forming apparatuses are comparatively expensive, and require a certain amount of space for installment. Therefore, a usual printing system includes only one of such image forming apparatuses, where the image forming apparatus is connected to a plurality of client terminals via a network.

However, such a printing system has the following problem. Among a plurality of users in the printing system, some users must be seated far from the image forming apparatus, and so have difficulty in finding out whether their print job has ended. Therefore, cases arise where such users, coming to fetch the printout, find the print job incomplete even when a predetermined time has passed after they have issued a print request.

To counter this problem, a Japanese Laid-open patent application H10-285329 proposes the following printing system for example. In this printing system, an image forming apparatus, upon completion of a print job in accordance with a print request received from a user (client terminal), notifies the client terminal of the completion. The client terminal, being notified of the completion, reports the completion to the user by displaying information such as a job completion display 900 on a monitor as shown in FIG. 1.

However, in a conventional printing system, when a number of print requests are issued to an image forming apparatus, for example, the same number of completion notifications are sequentially displayed to a monitor, which is sometimes an annoyance to users.

### SUMMARY OF THE INVENTION

The present invention has been conceived in view of the above-stated problem, and has an object of providing a printing system and a printer driver, which enable reporting of print job completion without making users feel annoyed, even when there are a plurality of print requests.

So as to achieve the above object, a printing system of the present invention has an image forming apparatus and a client terminal, the image forming apparatus executing a print job for image forming that the client terminal has transmitted in accordance with a user's request and transmitting completion information regarding job completion of the print job to the client terminal upon completion of the print job, and the client terminal reporting completion of the print job to the user by means of a notification, upon receiving the completion information from the image forming apparatus, where the client terminal includes: a halting unit for, when a predetermined print-job related condition is satisfied, creating a halt state in which any completion reporting is halted; and a reporting unit for, upon cancellation of the halt state, reporting completion of all print jobs whose completion reporting has been halted in the halt state, by means of a lesser number of notifications than a total number of the print jobs.

For example, suppose a case where completion reporting has been halted for four print jobs. Then completion reporting of the halted four jobs may be collectively performed in any of the following ways: (a) one notification; (b) by two notifications each for two jobs; and (c) by two notifications, one for one job and the other for three jobs.

With the stated structure, when completion reporting has been halted for a plurality of print jobs, the job completion is collectively reported. In other words, the halted completion reporting is performed to the user by means of a lesser number of notifications than a total number of print jobs whose completion reporting has been halted in the halt state. Therefore, the user will be relieved of the annoyance of receiving a job completion notification each time a print job completes.

Here, the client terminal may include: a judgment unit for judging whether the predetermined print-job related condition is satisfied; and a cancellation judgment unit for judging whether the halt state has been cancelled, the judgment unit judges that the predetermined print-job related condition is satisfied when a number of transmitted print jobs to the image forming apparatus does not match a number of completed print jobs counted based on completion information received from the image forming apparatus, and the cancellation judgment unit judges that the halt state has been cancelled when the number of transmitted print jobs matches the number of completed print jobs.

In addition, the judgment unit and the cancellation judgment unit may perform judgment with respect to print jobs sharing common information.

With the stated structures, the comparison of the number of transmitted print jobs and the number of completed print jobs is performed with respect to the print jobs sharing common information. This means that completion reporting is performed for the print jobs having something in common. The user is further enabled to grasp an operational state of the print jobs having something in common.

Here, the common information may be storage information relating to data storage regarding the print jobs.

With the stated structure, when for example a client terminal manages files regarding print jobs for each folder, the number of transmitted/received jobs will be also counted for each folder. Therefore, if the files are classified into folders with clear objectives, completion reporting is also performed for each classification group. Accordingly, the user is enabled to grasp an operational state of print jobs that serve the same objective.

Note that the “storage information” is a concept including: a name of data (file name) relating to a print job, which is used in storing the data in a storage unit or the like; and a storage destination (folder name) of the data.

Here, the common information may relate to an application on which the print jobs are created.

With the stated structure, the comparison of the number of transmitted print jobs and the number of completed print jobs is performed for print jobs created on a same application. Accordingly, completion reporting is performed for each application. The user is further enabled to grasp an operational state of print jobs that serve the same objective.

Here, the common information may be a keyword assigned by the user.

With the stated structure, the comparison of the number of transmitted print jobs and the number of completed print jobs is performed for print jobs having a same keyword (assigned with clear objectives). Accordingly, completion reporting is performed for each keyword. The user is further enabled to grasp an operational state of print jobs that serve the same objective.

Here, the printing system may further have one or more image forming apparatuses that are identical in structure to the image forming apparatus, where the common information identifies a corresponding image forming apparatus to which the print jobs are issued.

With the stated structure, the comparison of the number of transmitted print jobs and the number of completed print jobs is performed for each image forming apparatus. Accordingly, completion reporting is performed for each image forming apparatus. The user is further enabled to grasp which image forming apparatus has completed its print jobs. Accordingly, the user can go fetch printouts at the right image forming apparatus in right timing.

Here, the reporting unit may perform the halted completion reporting to the user before the cancellation of the halt state, if a different predetermined print-job related condition from the predetermined print-job related condition is satisfied during the halt state.

In this structure, the “completion reporting” may involve one or more print jobs.

Here, the reporting unit may perform the halted completion reporting to the user before the cancellation of the halt state, if during the halt state a predetermined time has passed after transmission of a print job transmitted the last of all the print jobs.

In this structure, the “completion reporting” may involve one or more print jobs.

With the stated structure, when for example the image forming apparatus was unable to report job completion of a print job to the client terminal for some reason, completion reporting for so-far completed print jobs is performed in right timing. Therefore, the user does not have to wait for a print result too long.

Here, the client terminal may include an estimation unit for estimating a time required for executing a print job in/after transmitting the print job to the image forming apparatus, and the reporting unit performs completion reporting to the user before the cancellation of the halt state, if the estimated execution time is a predetermined length or longer.

In this structure, the “completion reporting” may involve one or more print jobs.

With the stated structure, when the estimated execution time is a predetermined length or longer, reporting of the latest printing state is performed in right timing, without waiting for the completion of the corresponding print job.

Here, a structure is possible in which the image forming apparatus transmits, to the client terminal, image forming information relating to execution of the print jobs, and

the reporting unit performs completion reporting to the user before the cancellation of the halt state, if the image forming information is predetermined information.

In addition, the predetermined information may indicate an printing error occurred in execution of the print jobs.

Here, the “completion reporting” may involve one or more print jobs.

With the stated structure, when an error has occurred in the image forming apparatus, completion reporting for the so-far completed print jobs and error occurrence reporting are performed to the user at the same time. Therefore, the user can fix the error immediately, to restore the print job processing thereafter.

Here, the reporting unit may perform the halted completion reporting to the user before the cancellation of the halt state, if the number of completed print jobs has reached a predetermined number, where the number of completed print jobs has been judged based on completion information received from the image forming apparatus.

In this structure, the “completion reporting” may involve one or more print jobs.

With the stated structure, when for example a large amount of print jobs have been transmitted from a client terminal to an image forming apparatus, completion reporting is performed at the time when the number of completed print jobs has reached a predetermined number, without waiting for the completion of all the transmitted print jobs. Therefore, the user is able to grasp which print jobs have been completed on a monitor.

Here, a structure is possible in which the reporting unit, if the image forming apparatus has performed predetermined processing during the halt state, performs the following to the user before the cancellation of the halt state: completion reporting; and reporting that the predetermined processing has been performed.

In this structure, the “completion reporting” may involve one or more print jobs.

With the stated structure, when for example the image forming apparatus has performed rounding processing, it immediately performs: completion reporting and reporting that the rounding processing has been performed. Accordingly, when the user is unable to admit the rounding processing on the particular print job, he can deal with the case immediately.

Here, the predetermined processing may be executing of a print job in setting different from setting instructed with respect to the print job.

In addition, a structure is possible in which the client terminal includes a counting unit for counting the number of transmitted print jobs, and when an instruction not to perform a print job already transmitted to the image forming apparatus is received, the counting unit subtracts one from the number of transmitted print jobs.

With the stated structure, when for example an already issued print job is cancelled, an inconsistency between the number of transmitted jobs and the number of completed jobs will not be caused.

Here, a structure is possible in which the client terminal includes a counting unit for counting the number of transmitted print jobs, and when a print job already transmitted to the image forming apparatus is of a predetermined type, the counting unit subtracts one from the number of transmitted print jobs.

With the stated structure, when for example an issued print job requires that processing thereof should be postponed, an inconsistency between the number of transmitted jobs and the number of completed jobs will not be caused.

So as to achieve the above object, a printing system of the present invention has a relay unit, an image forming unit, and a job reception unit, the job reception unit transmitting a print job for image forming in accordance with a user's request to the image forming unit via the relay unit, the image forming unit executing the print job, and upon completion of the print job, transmitting completion information regarding job completion of the print job to the relay unit, the relay unit transmitting completion-information related information relating to the completion information to the job reception unit, and the job reception unit reporting completion of the print job to the user by means of a notification, upon receiving the completion-information related information from the relay unit, where the relay unit includes: a halting unit for, when a predetermined print-job related condition is satisfied, creating a halt state in which any transmission of completion-information related information is halted; and a transmission unit for, upon cancellation of the halt state, transmitting all pieces of completion-information related information whose transmission has been halted in the halt state, in a form organized into a lesser number of groups than a number of the pieces of completion-information related information.

Here, in some cases, “completion-information related information” can be the same as the completion information transmitted from the image forming unit. However, a distinction is made therebetween, because the completion information may change in form during transmission via the relay unit.

With the stated structure, too, when completion reporting has been halted for a plurality of print jobs, the job completion is collectively reported. In other words, the halted completion reporting is performed to the user by means of a lesser number of notifications than a total number of print jobs whose completion reporting has been halted in the halt state. Therefore, the user will be relieved of the annoyance of receiving a job completion notification each time a print job completes.

Furthermore, so as to achieve the above object, the present invention provides a printer driver that is installed in a client terminal and is connected to an image forming apparatus, the image forming apparatus executing a print job for image forming that the client terminal has transmitted in accordance with a user's request and transmitting completion information regarding job completion of the print job to the client terminal upon completion of the print job, and the client terminal reporting completion of the print job to the user by means of a notification, upon receiving the completion information from the image forming apparatus, the printer driver performing the following: halting processing of, when a predetermined print-job related condition is satisfied, creating a halt state in which any completion reporting is halted; and reporting processing of, upon cancellation of the halt state, reporting completion of all print jobs whose completion reporting has been halted in the halt state, by means of a lesser number of notifications than a total number of the print jobs.

With the stated structure, too, when completion reporting has been halted for a plurality of print jobs, the job completion is collectively reported. In other words, the halted completion reporting is performed to the user by means of a lesser number of notifications than a total number of print jobs whose completion reporting has been halted in the halt state. Therefore, the user will be relieved of the annoyance of receiving a job completion notification each time a print job completes.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a diagram showing one example of display;

FIG. 2 is a diagram showing an entire structure of a printing system relating to a first embodiment;

FIG. 3 is a block diagram showing a structure of an MFP relating to the first embodiment;

FIG. 4 is a block diagram showing a hardware structure of a client terminal relating to the first embodiment;

FIG. 5 is a diagram showing a software structure of the client terminal relating to the first embodiment;

FIG. 6 is a structural diagram showing a display management table relating to the first embodiment;

FIG. 7 is a diagram showing a flowchart regarding a job transmission unit relating to the first embodiment;

FIG. 8 is a diagram showing a flowchart regarding a display management control unit relating to the first embodiment;

FIG. 9 is a diagram showing a display management table relating to a first modification example;

FIG. 10 is a diagram showing a flowchart regarding a display management control unit relating to the first modification example;

FIG. 11 is a diagram showing a printer driver relating to a second embodiment;

FIG. 12 is a diagram showing a display management table is relating to the second embodiment;

FIG. 13 is a diagram showing a flowchart regarding a display management control unit relating to the second embodiment;

FIG. 14 is a diagram showing a flowchart regarding a first display management control unit relating to a third embodiment;

FIG. 15 is a diagram showing a flowchart regarding a second display management control unit relating to the third embodiment;

FIG. 16 is a diagram showing a flowchart regarding a display management control unit relating to a fourth embodiment;

FIG. 17 is a diagram showing a display management table relating to a fifth embodiment;

FIG. 18 is a diagram showing a flowchart regarding a display management control unit relating to the fifth embodiment;

FIG. 19 is a diagram showing a flowchart regarding a display management control unit relating to a sixth embodiment;

FIG. 20 is a diagram showing a flowchart regarding a job deletion unit relating to a second modification example;

FIG. 21 is a diagram showing a flowchart regarding a job transmission unit relating to a third modification example;

FIG. 22 is a diagram showing an entire structure of a printing system relating to a fourth modification example;

FIG. 23 is a diagram showing a display management table relating to the fourth modification example; and

FIG. 24 is a diagram showing a flowchart regarding a display management control unit relating to the fourth modification example.

### DESCRIPTION OF THE PREFERRED EMBODIMENTS

The following describes an embodiment in which an MFP is adopted as the image forming apparatus of the present invention. Note that the MFP is one example of the image forming apparatus. There are other types of image forming apparatus, such as a printer, and a multifunction printer.

### First Embodiment

1. Entire Structure

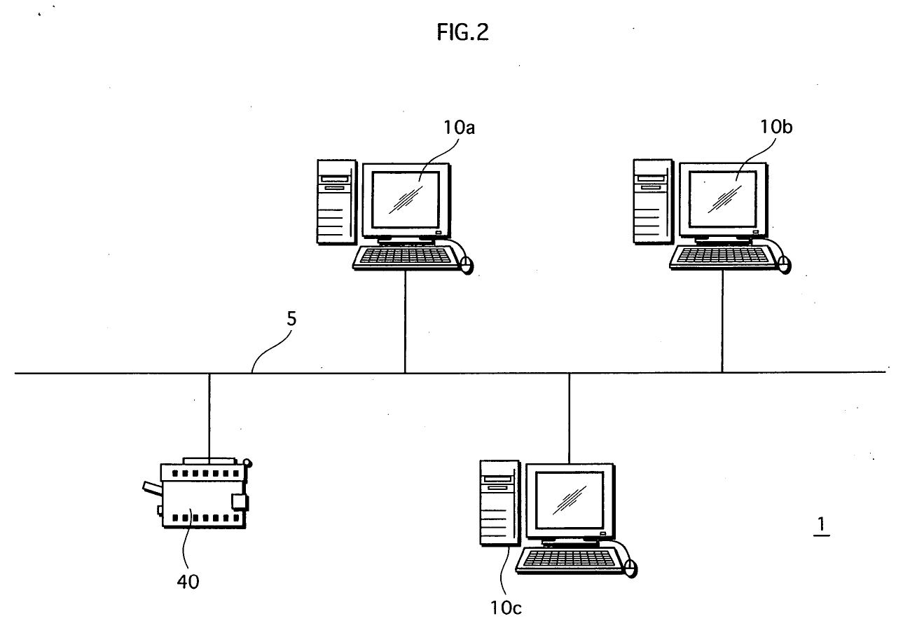

FIG. 2 is a diagram showing an entire structure of a printing system relating to the first embodiment.

As shown in this drawing, in a printing system 1, client terminals 10a, 10b, 10c, and an MFP 50 are connected to each other via a network (LAN 5).

The client terminals 10a, 10b, 10c, and the MFP 50 are specifically connected to a LAN cable via a hub (not shown in the drawing), and are communicable to each other using a TCP/IP protocol. With this structure, the MPF50 for example is capable of receiving a print request from the client terminals 10a, 10b, and 10c. Although there is no particular mention in the description, the present printing system 1 may be connected to the Internet, for example, via a router not shown in the drawing.

2. MFP

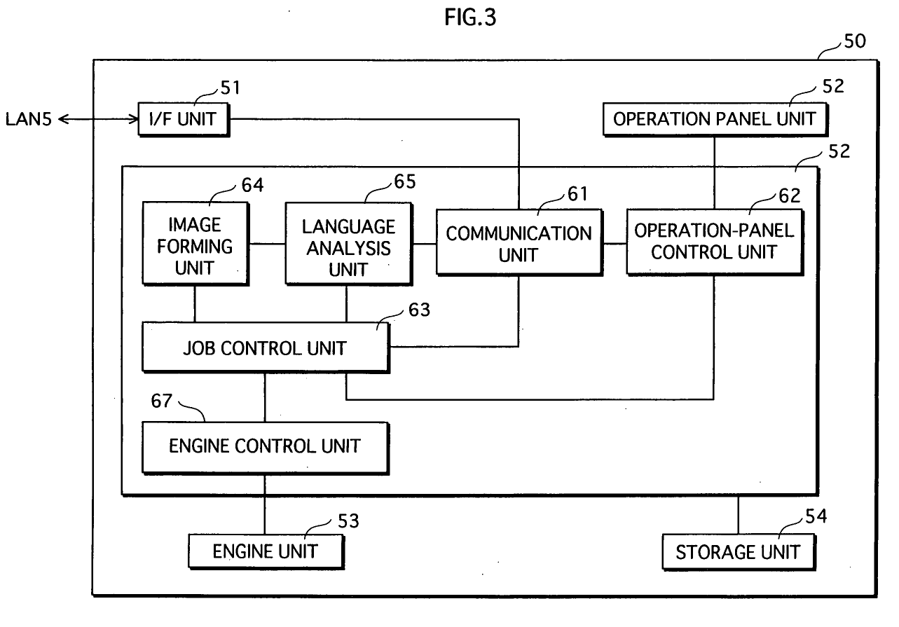

FIG. 3 is a block diagram showing a structure of the MFP relating to the first embodiment.

As shown in FIG. 3, the MFP 50 is comprised of: an interface (I/F) unit 51, a main control unit 52, an engine unit 53, a storage unit 54, an operation panel unit 55, and so on.

The I/F unit 51 is an interface for connecting to the LAN 5 (e.g. a LAN card, a LAN board). The operation panel unit 55 is, for example, equipped with a touch panel unit, a ten-key unit, an input unit, or the like (not shown in the drawing).

The touch panel unit is used for the following purposes, for example: inputting various types of setting relating to the MFP 50 in accordance with the display; displaying completion of a print job; and displaying an error message caused during execution of a print job.

Note that the various types of setting, mentioned above, include network setting necessary for communication with the client terminal 10a and the like (e.g. IP address). Information inputted via the touch panel unit is outputted to the main control unit 52. Then, in accordance with the inputted information, the main control unit 52 instructs the operation panel unit 55 to control the touch panel unit to present a next display necessary for the next input operation.

The storage unit 54 performs the following for example: storing various types of data; offering a work area for various types of processing executed by the main control unit 52; and storing a print job management table for storing information relating to print jobs either received or processed on a day, or the like.

The engine unit 53 adopts a publicly-known electrophotographic method, for example. The main task of the engine unit 53 is to supply printing paper from a printing bin, transfer (form) an image onto the paper, and discharge the paper to a discharge bin, in accordance with a print-job related instruction issued from the main control unit 52.

The main control unit 52 is comprised of: a communication unit 61; an operation-panel control unit 62, a job control unit 63, an image forming unit 64, a language analysis unit 65, and an engine control unit 67. An example of the main control unit 52 is a CPU.

The communication unit 61 mainly controls the I/F unit 51, so as to receive a print job from a client terminal (10a etc.), notify the client terminal (10a etc.) of the completion of the print job, and transmit various types of image-forming related information.

The language analysis unit 65 analyzes printing data 40 having been received, and outputs the data necessary for image forming to the image forming unit 64, and the printing information necessary in executing the print job (e.g. number of copies, orientation, information on whether double-side printing or not) to the job control unit 63.

The image forming unit 64 converts the received data (e.g. in PDL format) into bit-mapped image data, for example, and outputs the bit-mapped image data to the job control unit 63.

The job control unit 63 temporarily stores, in the storage unit 54, the image data received from the image forming unit 64 and the printing information received from the language analysis unit 65. In addition, the job control unit 63 issues a print request to the engine control unit 67, for requesting printing of the image data according to the printing information.

The engine control unit 67 drives the engine unit 53 to form an image on paper, and outputs a processing result to the job control unit 63 upon completion of the print job. The job control unit 63, upon reception of the processing result, analyses the processing result, and outputs information relating to the image forming (hereinafter simply “image forming information) to the communication unit 61 and the operation-panel control unit 62. Examples of the image forming information are: information indicating completion of processing relating to a print job (hereinafter simply “job completion information); and printing-result information (e.g. showing whether the printing has ended normally).

Receiving the image forming information, the communication unit 61 transmits a notification that there is the image forming information (“image forming information notification) to the client terminal (10a etc.) that has requested the printing, and the operation-panel control unit 62 displays the received printing-result information to the operation panel unit 55. Note that after transmission of the image forming information notification, if the communication unit 61 receives a notification that the client terminal requires the image forming information, the communication unit 61 is operable to transmit the required image forming information to the client terminal.

If the MFP 50 has a copy function, the operation-panel control unit 62 will have a function for receiving copy-related setting such as number of pages, scaling selection, and paper selection.

3. Client Terminal

As follows, the client terminals 10a, 10b, and 10c are described. The three client terminals are basically the same in structure and the like, and so are collectively referred to as “client terminal 10” in the following explanation.

(1) Hardware Structure

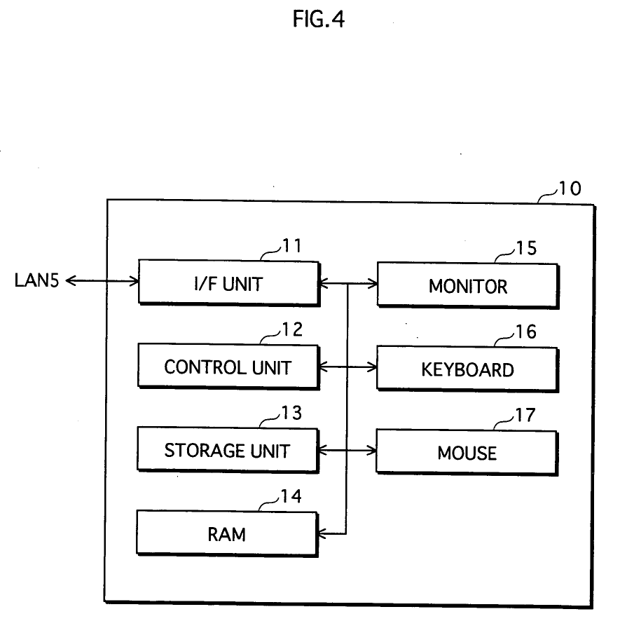

FIG. 4 is a block diagram showing a hardware structure of a client terminal relating to the first embodiment.

As shown in this drawing, the client terminal 10 is comprised of: an interface (I/F) unit 11, a control unit 12, a storage unit 13, a RAM 14, a monitor 15, a keyboard 16, a mouse 17, and the like. An example of the client terminal 10 is a personal computer (PC).

The I/F unit 11 is an interface for connecting to the LAN 5 (e.g. a LAN card, a LAN board).

The storage unit 13 is a hard disk, for example, and stores therein an operating system (OS) 20 (see FIG. 4), an application 22, a printer driver 24, and so on. The printer driver 24 is used in requesting a printing to the MFP 50.

The RAM 14 offers a work area for various types of processing executed by the control unit 12.

The control unit 12 is a CPU. The control unit 12 controls contents to be displayed on the monitor 15, and receives information inputted through the keyboard 16 and the mouse 17. In addition, the control unit 12 executes the functions of the OS 20 stored in the storage unit 13, and the like.

(2) Software Structure

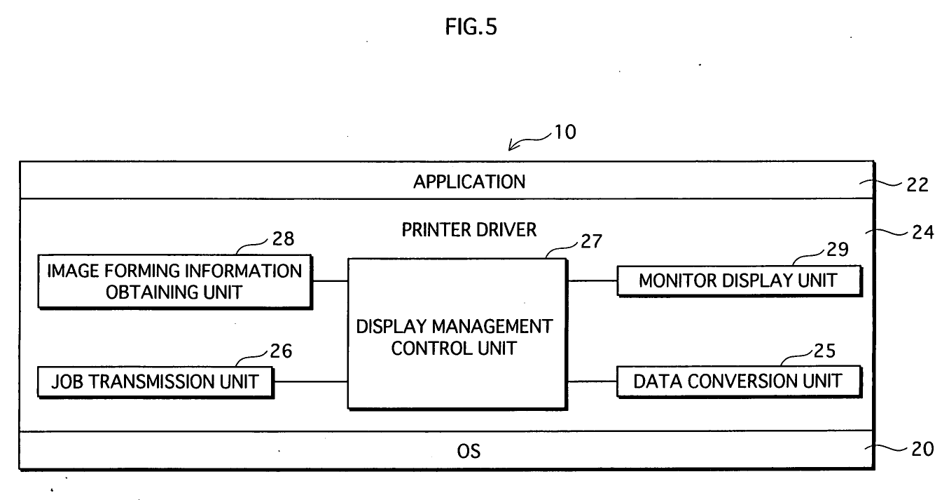

FIG. 5 is a diagram showing a software structure of the client terminal relating to the first embodiment.

As shown in this drawing, in the client terminal 10, the following software is installed: an OS 20, an application 22, a printer driver 24, as well as a monitor driver and the like not shown in the drawing.

The OS 20 corresponds to a network, and is basic software for a user of the client terminal 10 to operate the PC. The OS 20 performs management directed to the storage unit 13, the RAM 14, and the like, such as memory management and file management such as storing/reading of files.

The application 22 operates on the OS 20, and includes many types such as for the purpose of document creation, graphics creation, and table creation with computing power. The application 22 is installed via the OS 20, and is stored in the storage unit 13.

When there is a print request on the application 22, the printer driver 24 manages the entire printing relating to the print request. Not only that, when a print job requested to the MFP 50 (the expression “instructed to” is also used in the present specification) has been complete, the printer driver 24 is necessary for displaying information indicating the completion on the monitor 15. As shown in FIG. 5, the printer driver 24 includes a data conversion unit 25, a job transmission unit 26, an image forming information obtaining unit 28, a display management control unit 27, and a monitor display unit 29.

The printer driver 24 performs the following: halt processing for, when a predetermined print-job related condition is satisfied, creating a halt state in which any completion reporting is halted; and reporting processing for, upon cancellation of the halt state, collectively reporting completion of all print jobs whose completion reporting has been halted in the halt state. In this particular example, “collectively reporting” means that the halted completion reporting is performed by means of one notification.

The data conversion unit 25, when there is a print request from a user, converts data for printing created in the application 22 that is in a format unique to the application 22, into data in a print description language (PDL) format, for example. Note that the header of the data for printing includes an identifier of the client terminal, a serial number of a print job that the client terminal is requesting to the MFP 50, and the like. The identifier of the client terminal is used by the MFP 50 in judging which client terminal has issued the print request.

The job transmission unit 26 transmits, to the MFP 50, the data in the PDL format resulting from the data conversion unit 25. The form at of the data is not limited to the PDL format. The job transmission unit 26 also has a function of counting the number of jobs having been transmitted to the MFP 50 (hereinafter simply “number of transmitted jobs”). Note that the number of transmitted jobs is managed in a display management table detailed later.

The image forming information obtaining unit 28 receives an image forming information notification. The image forming information obtaining unit 28 also instructs the MFP 50 to transmit the image forming information when necessary, to obtain the image forming information. Note that upon reception of job completion information, the image forming information obtaining unit 28 outputs the job completion information to the display management control unit 27 detailed later.

The display management control unit 27 counts the number of pieces of job completion information (hereinafter simply “the number of completed jobs”) received from the image forming information obtaining unit 28. When the counted number of completed jobs reaches the number of transmitted jobs to the MFP 50, the display management control unit 27 instructs the monitor display unit 29 to display the completion of the print jobs. Hereinafter, this instruction is simply called “job completion display instruction”.

When there is an application print request, the monitor display unit 29 performs a display for receiving a modification instruction of printing-related information upon request by a user. The monitor display unit 29 also performs a job completion display, upon receiving a job completion display instruction.

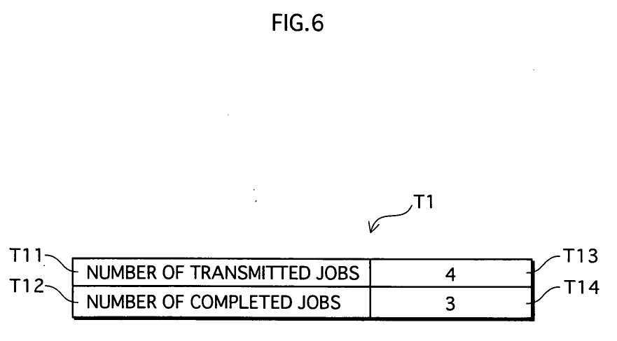

FIG. 6 is a structural diagram showing a display management table T1 relating to the first embodiment.

As shown in this drawing, the display management table T1 has two columns: “number of transmitted jobs” column T11; and “number of completed jobs” column T12. Corresponding numbers are respectively stored in the storage columns T13 and T14.

(3) Operations

(3-1) Job Transmission Unit

The operation of the job transmission unit 26 is described as follows.

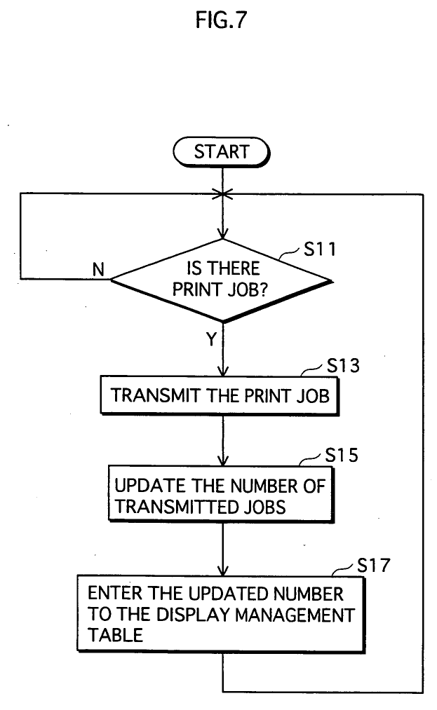

FIG. 7 is a diagram showing a flowchart regarding the job transmission unit relating to the first embodiment.

The job transmission unit 26 judges whether there is a print job to be transmitted. Here, this is specifically judged by checking whether there is data converted by the data conversion unit 25.

When there is a print job to be transmitted to the MFP 50 (Step S11:Y), the print job is transmitted (Step S13), and the number of transmitted jobs is updated (Step S15). The updated number is entered in the storage column T13 in the display management table T1 (FIG. 6). When there is no print job to be transmitted in Step S11, the presence of print job is repeatedly judged until there is a print job.

According to the above-stated operation, the number of transmitted jobs will be accurately managed. Please note that the clearing of the number of transmitted jobs to “0” is performed at the activation of the client terminal 10, or the like, although the specific timing is not shown in the flowchart.

(3-2) Display Management Control Unit 27

Next, the operation of the display management control unit 27 is described as follows.

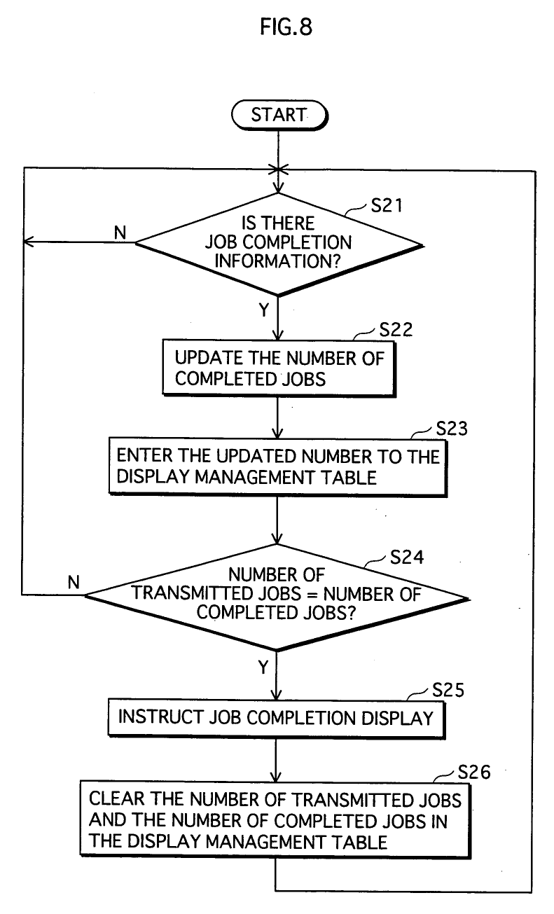

FIG. 8 is a diagram showing a flowchart regarding the display management control unit 27 relating to the first embodiment.

The display management control unit 27 judges whether there is job completion information transmitted from the image forming information obtaining unit 28 (Step S21). When there is job completion information, updates the number of completed jobs (Step S22), and the updated number is entered in the storage column T14 in the display management table T1 (Step S23).

Then it is judged whether the number of transmitted jobs matches the number of completed jobs, using the display management table T1 (Step S24). When they do not match (Step S24:N), the control returns to Step S21.

When they are judged to match (Step S24:Y), the display management control unit 27 issues a job completion display instruction to the monitor display unit 29 (Step S25), and clears the number of transmitted jobs and the number of completed jobs to “0” in the display management table T1 (Step S26).

4. Summary

As described above, in the present embodiment, when the client terminal 10 has transmitted a plurality of print requests sequentially for example, the printer driver 24 monitors the number of print jobs transmitted from the client terminal 10 (number of transmitted jobs) and the number of pieces of job completion information obtained from the MFP 50 incident to completion of print jobs (number of completed jobs), so that a job completion display is controlled to be presented on the monitor 15 of the client terminal 10 when the number of transmitted jobs matches the number of completed jobs. Therefore, even when the client terminal is in a remote place from the MFP, a user can go the MFP to fetch the printout after confirming the job completion display, just as in the conventional case.

In addition, when there are several sequential print jobs, a job completion display is presented after completion of all the sequential print jobs. Therefore, the user is relieved of the annoyance of seeing a job completion display at the monitor each time a print job completes.

5. Other Notes

In the above-described example, the printer driver 24 performs a job completion display when the number of transmitted jobs matches the number of completed jobs. However, when there is an error in the MFP or the like before the completion of the last one of a plurality of print jobs transmitted from a client terminal, a job completion display will not be performed even after a certain period of time.

The first modification example, described in the following, is conceived in view of such a case. In this first modification example, a printer driver performs a job completion display for print jobs having been completed so far, when a predetermined time has passed after reception of job completion information of a print job which is not the last one of print jobs issued from a client terminal.

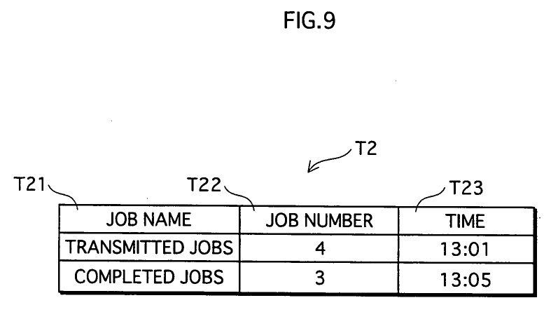

FIG. 9 is a diagram showing a display management table relating to the first modification example.

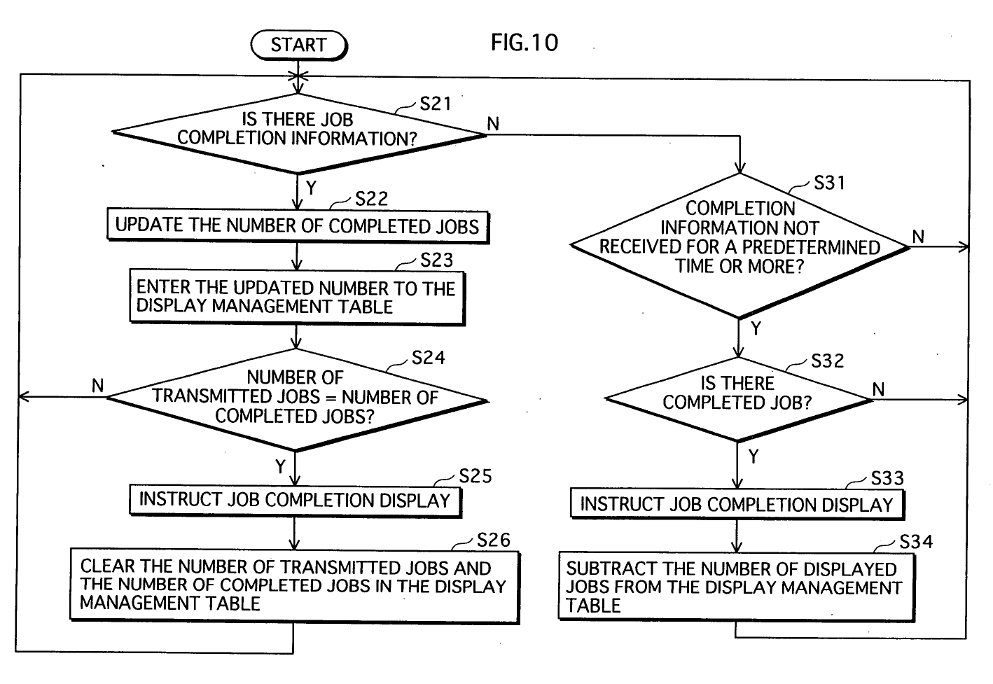

FIG. 10 is a diagram showing a flowchart regarding a display management control unit relating to the first modification example.

A display management table T2 (FIG. 9) is similar to the display management table T1 (FIG. 6) of the first embodiment, except that “time” column T23 is added thereto to show a time at which a print job is transmitted to the MFP as well as a time at which job completion information is received from the MFP. Note that although the display management table T1 does not have the “job name” column T21 or “job number” column T22, it is a mere difference in table format from the display management table T2 and not of substance.

In the first embodiment, the display management control unit is controlled to return to Step S21 when there is no job completion information (see FIG. 8). However in the first modification example, when it is judged that there is no job completion information in Step S21, the display management control unit is controlled to proceed to Step S31 (see FIG. 10)

The following details the operation performed after Step S31.

In Step S31, it is judged whether job completion information has not been received for a predetermined time or more. Specifically, using the display management table T2, a difference between a current time and a time “13:05” (in column T23) corresponding to “completed job” is calculated, and then it is judged whether the calculated difference is equal to a predetermined time or greater.

If the calculated difference is judged to be equal to or greater than the predetermined time, the control proceeds to Step S32, where it is judged whether there is any completed print job(s). Specifically, it is judged by checking the display management table T2 to see whether “job number” column T22 corresponding to “completed job” shows a value other than “0”.

When there is any completed print job(s), the control proceeds to Step S33, and the monitor display unit 29 is instructed to display a job completion display for the completed print job(s) so far (Step S33). Then after subtracting the displayed number of jobs from the value entered in the “job number” column T22, the control returns to Step S21. Note that when a predetermined time has not passed in Step S31 (Step S31:N), the control also returns to Step S21.

In the above structure, a job completion display for print jobs completed so far is performed when a predetermined time has passed after reception of job completion information. Therefore, when a user of the client terminal 10 has requested a plurality of print jobs to the MFP 50, he can grasp the printing progress, which is particularly advantageous when the user requires the printouts immediately.

### Second Embodiment

The above-described first embodiment is designed to perform a job completion display on the monitor 15, for informing a user of the client terminal 10 of the print job completion, when the number of transmitted jobs to the MFP 50 matches the number of completed jobs in the MFP 50.

The printer driver of the second embodiment estimates the time required for executing a print job to be transmitted, and if the estimated time is equal to or greater than a predetermined time, performs a job completion display for print jobs completed so far.

1. Structure

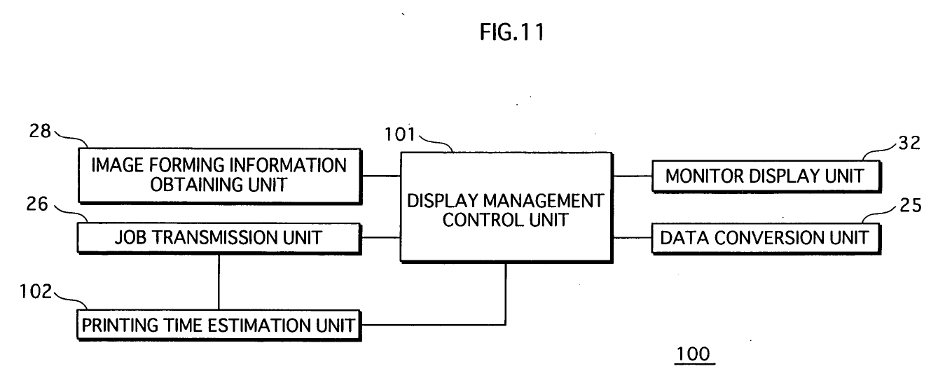

FIG. 11 is a diagram showing the printer driver relating to the second embodiment.

As shown in FIG. 11, a printer driver 100 of the second embodiment includes a data conversion unit 25, a job transmission unit 26, an image forming information obtaining unit 28, a monitor display unit 32 (the components so far are the same as those in the first embodiment), a display management control unit 101, and a printing time estimation unit 102.

When transmitting a print job to the MFP 50, the job transmission unit 26 notifies the display management control unit 101 of the transmission. The job transmission unit 26 also enters a time at which the print job was transmitted in the “transmission time” column 1T12 in the later-detailed display management table 1T1, after transmission of the print job.

The printing time estimation unit 102 estimates a time required for executing a transmitted print job, and transmits the estimated printing time to the display management control unit 101. Hereinafter, a time required for executing a print job is occasionally referred to as “printing time”. The estimation is performed by referring to a print job capacity, a type of PDL, an adopted application, and the like. Here, the printer driver 100 performs the estimation of a printing time. However it is also possible to receive a scheduled completion time of the print job from the MFP 50, for example. In such a case, the MFP 50 has naturally received print jobs from other client terminals 10, and so can estimate a more accurate time required before completion of the print job, because the reception state and the execution state of print jobs in the MFP 50 can also be used in the estimation. The printing time estimated in the printing time estimation unit 102 is entered in the display management table 1T1 by the display management control unit 101, the display management table 1T1 being detailed next.

2. Display Management Table

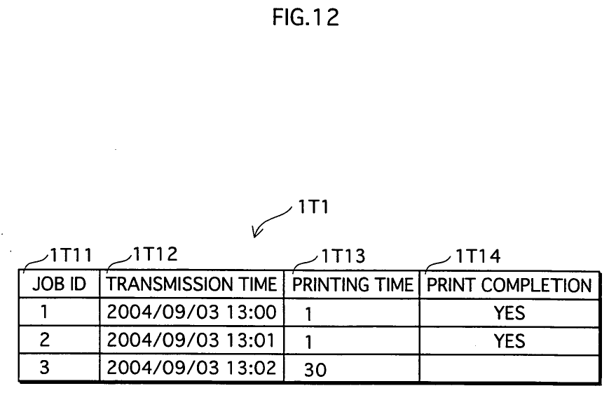

FIG. 12 is a diagram showing a display management table relating to the second embodiment.

As shown in FIG. 12, the display management table 1T1 has four columns: “job ID” column 1T11; “transmission time” column 1T12; “printing time” column 1T13; and “print completion” column 1T14.

The job transmission unit 26, either when or after transmitting a print job to the MFP 50, enters the transmission time thereof to the “transmission time” column 1T12, with the latest job ID (the row corresponding to this job ID becomes the bottom row in the display management table 1T1). In addition, the image forming information obtaining unit 28, when obtaining job completion information from the MFP 50, enters “Yes” to the bottom row corresponding to the “print completion” column 1T14. The display management control unit 101, when obtaining a printing time from the printing time estimation unit 102, enters the printing time to the bottom row corresponding to the “printing time” column 1T13.

3. Display Management Control Unit

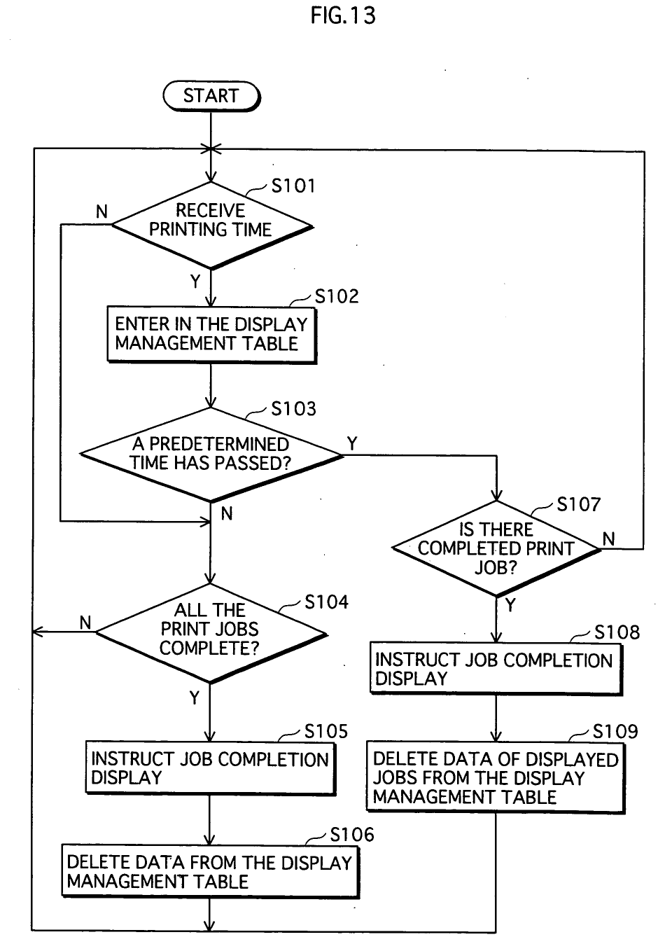

FIG. 13 is a diagram showing a flowchart regarding a display management control unit relating to the second embodiment.

The display management control unit 101 first judges whether a printing time has been received from the printing time estimation unit 102 (Step S101).

When it is judged that a printing time has been received, the printing time is entered in the “printing time” column 1T13 corresponding to the top row among the rows where no printing time has been entered in the display management table 1T1.

Then, it is judged whether the entered time is equal to or greater then a predetermined time (Step S103). When the judgment is in the negative (Step S103:N), it is then judged whether all the print jobs in the display management table 1T1 have been complete (Step S104). This judgment is specifically performed by checking whether the “print completion” column shows “Yes” for all the job IDs.

When all the print jobs have been complete (Step S104:Y), the monitor display unit 32 is instructed to perform a job completion display for these print jobs (Step S105). Then all the data for the displayed print jobs is deleted from the display management table 1T1 (Step S106). When the judgment is in the negative in Step S104 (Step S104:N), the control returns to Step S101.

On the other hand, when it is judged that the entered time is equal to or greater then a predetermined time (e.g. 5 minutes) (Step S103:Y), it is then judged whether there is any job in the display management table 1T1 that has been complete (Step S107). This judgment is specifically performed by checking whether the “print completion” column shows “YES” for any of the job IDs, in the similar way as in Step S104.

When there is any completed print job(s) (Step S107:Y), the monitor display unit 32 is instructed to perform a job completion display for the completed print job(s) (Step S108). Then all the data for the displayed print job(s) is deleted from the display management table 1T1 (Step S109), and the control returns to Step S101.

In the above-described structure, when execution of a transmitted print job is judged to take a predetermined time or more, a job completion display is performed for the so-far completed print jobs without waiting for the completion of this print job. Therefore, when a user of the client terminal 10 has requested a plurality of print jobs to the MFP 50, he can grasp the printing progress, which is particularly advantageous when the user requires the printouts immediately.

### Third Embodiment

The printer driver of the second embodiment estimates the time required for completing a print job to be transmitted, and if the estimated time is equal to or greater than a predetermined time, performs a job completion display for print jobs completed so far on the monitor 15.

On the other hand, a printer driver of the third embodiment performs a job completion display for print jobs completed so far on the monitor 15 when the information obtained by the image forming information obtaining unit involves particular contents.

The particular contents includes: information incident to an occurrence of error; and information incident to execution of rounding processing (detailed later).

1. Occurrence of Error

The following details a case where the information obtained by the image forming information obtaining unit is information incident to an occurrence of error. Note that a display management control unit used in this section is labeled “first display management control unit”.

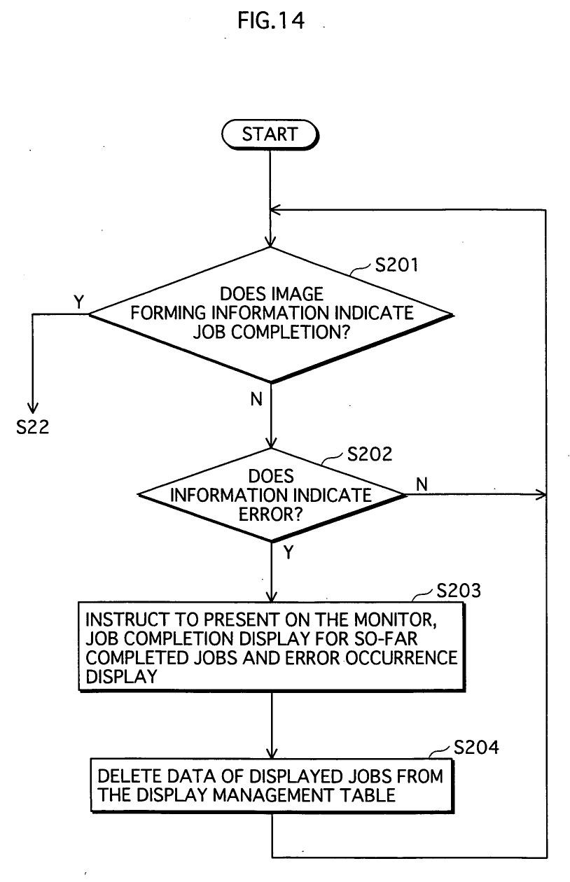

FIG. 14 is a diagram showing a flowchart regarding the first display management control unit relating to the third embodiment.

The first display management control unit judges whether the image forming information obtained by the image forming information obtaining unit is job completion information (Step S201). When the judgment is in the affirmative (Step S201:Y), the control proceeds to Step S22 of FIG. 8. The processing after Step S22 is the same as the processing after Step S22 in the flowchart of FIG. 8.

When the image forming information is judged not to be job completion information in Step S201 (Step S201:N), the control proceeds to Step S202, where it is then judged whether the image forming information relates to an error. If this judgment results in the affirmative, the monitor display unit 32 is instructed to perform, on the monitor 15, a job completion display for print jobs completed so far (having processed so far), as well as a display indicating that an error has occurred in the MFP (hereinafter “error occurrence display”).

Then, in Step S204, the data regarding the already displayed print jobs is deleted from the display management table, and the control returns to Step S201.

2. Rounding Processing

The following details a case where the information obtained by the image forming information obtaining unit is information incident to rounding processing. Note that a display management control unit used in this section is labeled “second display management control unit”.

In pursuing a print job, the MFP 50 basically follows printing information (e.g. print setting) transmitted from the client terminal 10. However, sometimes the MPF 50 cannot perform a print job according to the setting. In such a case, the MFP 50 performs printing in different setting from the instructed setting or by canceling the instructed setting. Such processing is referred t as “rounding processing”.

Therefore, in the rounding processing, the MFP 50 performs a print job received from the client terminal 10, in different setting from the setting that the client terminal 10 has instructed regarding the print job.

In one example of the rounding processing, “staple” is set in a print job request, however the MFP to which the print job request is directed does not have a stapling function, and so the MFP discharges printouts without stapling, instead of abandoning this print job.

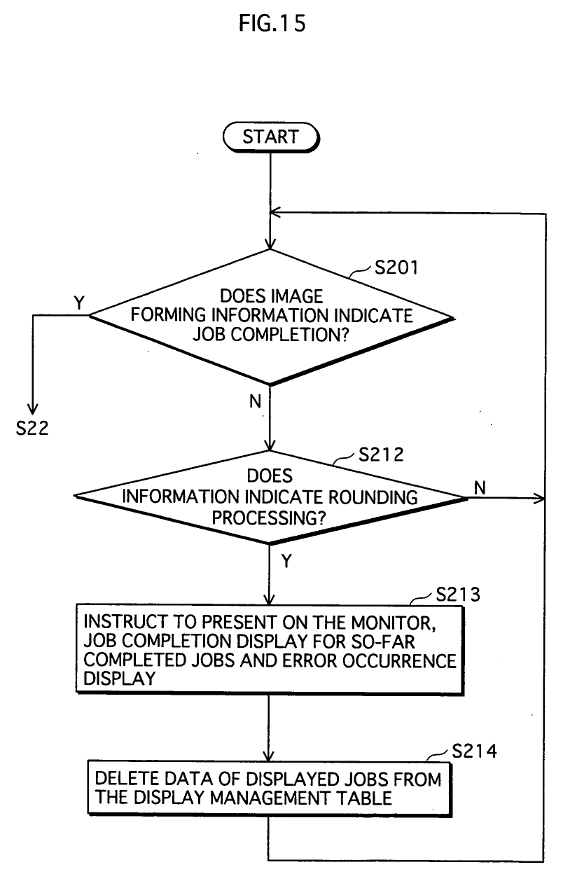

FIG. 15 is a diagram showing a flowchart regarding the second display management control unit relating to the third embodiment.

When it is judged, in Step S201, that the image forming information obtained by the image forming information obtaining unit is not job completion information (Step S201:N), the second display management control unit judges, in Step S212, whether the information relates to rounding processing. If this judgment results in the affirmative, the monitor display unit 32 is instructed to perform, on the monitor 15, a job completion display for print jobs completed so far, as well as a display indicating that the MFP 50 has performed rounding processing (hereinafter “rounding processing display”).

Then, in Step S214, the data regarding the already displayed print jobs is deleted from the display management table, and the control returns to Step S201.

3. Summary

Also in the above structure, even when the client terminal has transmitted print jobs sequentially and received job completion information for each of the print jobs from the MFP, the client terminal can collectively report completion of the print jobs on the monitor. Therefore, just as in the first embodiment, it is possible to lessen the annoyance of the user of the client terminal 10.

Furthermore, when the MFP undergoes an error or performs predetermined processing (e.g. rounding processing), the monitor 15 is controlled not only to display such an incident, but also to present a job completion display for print jobs completed so far. Accordingly, the user can obtain several kinds of information from one display.

### Fourth Embodiment

In the third embodiment described above, the printer driver performs a job completion display for print jobs completed so far on the monitor 15, when the information obtained by the image forming information obtaining unit involves particular contents (information).

A printer driver of the fourth embodiment performs a job completion display for jobs completed so far on the monitor 15 when the number of completed jobs has reached a predetermined number, even when the number of transmitted jobs does not match the number of completed jobs.

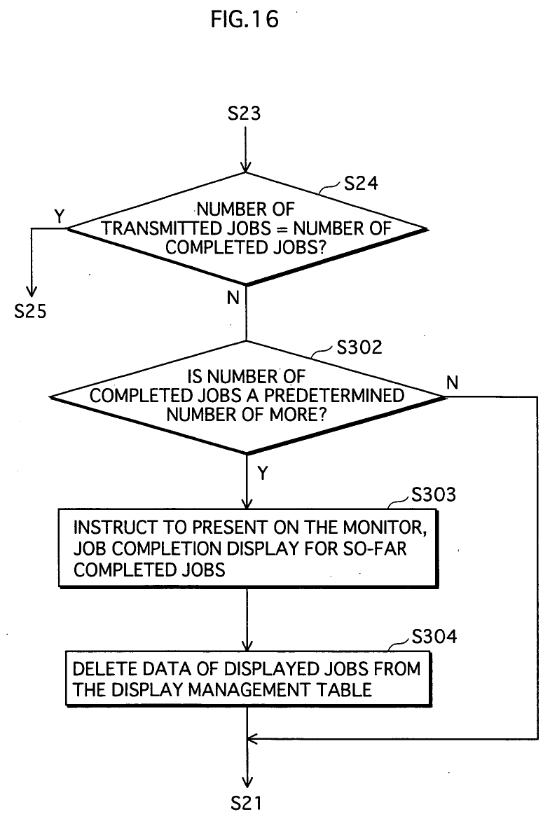

FIG. 16 is a diagram showing a flowchart regarding a display management control unit relating to the fourth embodiment.

The display management control unit relating to the fourth embodiment is designed to proceed to Step S302 when the judgment in Step S24 in FIG. 8 results in the negative (Step S24:N). In FIG. 16, the flow from Step S24 to Step S302 is illustrated.

As shown in FIG. 16, the display management control unit proceeds to Step S302 when the number of transmitted jobs does not match the number of completed jobs in Step S24. In Step S302, it is judged whether the number of completed jobs is equal to a predetermined number or greater, and when the judgment is in the negative (Step S302:N), the control returns to Step S21.

When the judgment in Step S302 is in the affirmative (Step S302:Y), the monitor display unit 32 is instructed to perform a job completion display for completed print jobs so far, on the monitor (Step S303). Then in Step S304, the data regarding the already displayed print jobs is deleted from the display management table, and the control returns to Step S21.

Also in this structure, even when the client terminal 10 has transmitted print jobs sequentially to the MFP 50, and received job completion information for each of the print jobs from the MFP 50, the client terminal 10 can collectively report completion of the print jobs on the monitor. Therefore, just as in the first embodiment, it is possible to lessen the annoyance of the user of the client terminal 10.

Furthermore, when the client terminal 10 has sequentially requested a large number of print jobs, the client terminal 10 can present a job completion display for print jobs completed so far when the number of completed jobs has reached a predetermined number, even before completion of all the requested jobs. Therefore, the user does not have to wait long till a job completion display is presented.

### Fifth Embodiment

The printer driver of the fourth embodiment performs a job completion display on the monitor 15 when the number of completed jobs has reached a predetermined number, even when the number of transmitted jobs does not match the number of completed jobs.

On the other hand, a printer driver of the fifth embodiment performs one job completion display for print jobs sharing common print-job related information, collectively. An example of such common print-job related information is a name of a folder storing a file corresponding to a print job. The following details this.

1. Structure

A user of a client terminal usually manages files to be printed according to a print request by folders. A printer driver obtains a folder name relating to a print job, and enters the folder name in the display management table when or after transmitting the print job to the MFP 50.

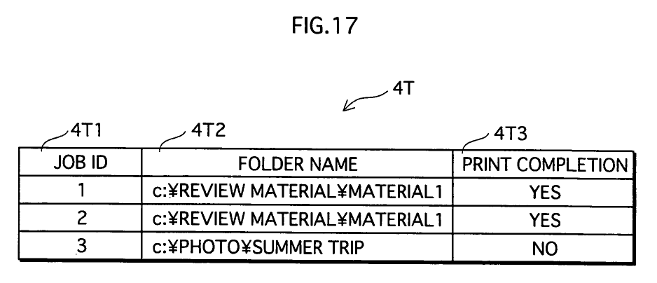

FIG. 17 is a diagram showing a display management table relating to the fifth embodiment.

As shown in FIG. 17, a display management table 4T has three columns: “job ID” column 4T1; “folder name” column 4T2; and “print completion” column 4T3.

When (or after) the job transmission unit transmits a print job to the MFP 50 for example, a corresponding folder name is entered in the “folder name” column 4T2, with the latest job ID (the row corresponding to this job ID becomes the bottom row in the display management table 4T). Meanwhile, when for example the display management control unit receives job completion information from the image forming information obtaining unit, “Yes” is entered in the bottom row corresponding to the “print completion” column 4T3 of the display management table 4T.

In the display management table 4T shown of FIG. 17, printing has been complete for the job IDs “1” and “2”, whose corresponding files are both stored under the folder name of “c:¥review material¥material1”, while printing for the job ID “3” is not complete yet.

2. Processing

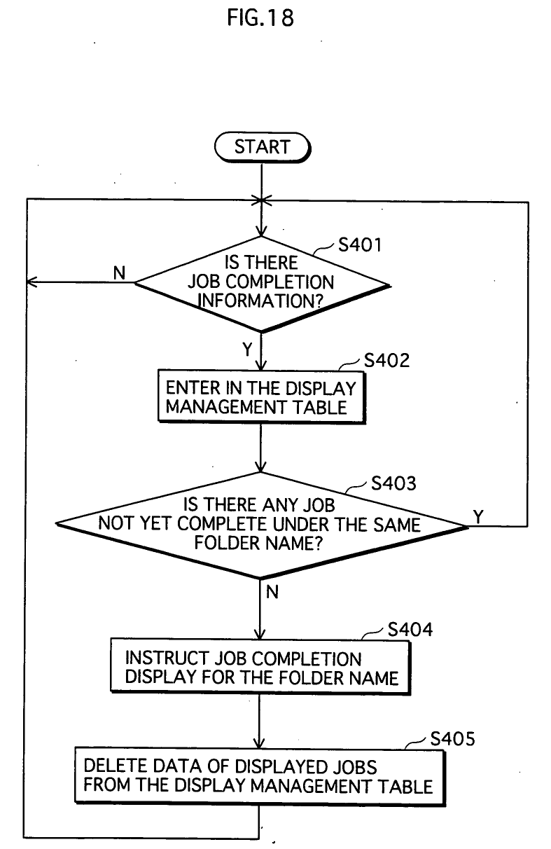

FIG. 18 is a diagram showing a flowchart regarding a display management control unit relating to the fifth embodiment.

The display management control unit, upon receiving job completion information from the image forming information obtaining unit (Step S401:Y), enters “Yes” in the “print completion” column 4T3 corresponding to the top print job among the print jobs whose processing has not been completed yet in the display management table 4T (Step S402).

Next, in Step S403, by checking the “folder name” column 4T2, it is judged whether there is any print job not yet complete under the same folder name within the display management table 4T. When the judgment is in the affirmative (Step S403:Y), the control proceeds to Step S401 to wait for the completion of the print job(s), so that a job completion display be performed collectively for the same folder name.

When the judgment in Step S403 is in the negative (Step S403:N), the monitor display unit 32 is instructed to perform a job completion display for the completed print jobs under the same folder name (Step S404). Then the data regarding the already displayed print jobs is deleted from the display management table (Step S405). Note that in Step S405, the corresponding data in the “folder name” column 4T2 and the “print completion” column 4T3 is deleted.

3. Summary

Also in this structure, even when the client terminal 10 has transmitted print jobs sequentially to the MFP, and there are print jobs whose files are stored in the same folder name, the client terminal 10 can collectively report completion of such print jobs on the monitor 15. Therefore, just as in the first embodiment, it is possible to lessen the annoyance of the user of the client terminal 10.

4. Other Notes

In the fifth embodiment, print-job related information is explained to be a name of a folder storing a file corresponding to a print job. However, the print-job related information is not limited to such, and may also be an application that has created a file, or may be a keyword assigned to a print job.

### Sixth Embodiment

In the above-described first to fifth embodiments, the basic principle is to perform a job completion display when the number of jobs transmitted from the client terminal 10 to the MFP 50 matches the number of jobs completed in the MFP 50.

However, a timing of the job completion display may be based on other predetermined conditions regardless of the number of transmitted/completed jobs.

In one example of the sixth embodiment, a job completion display is performed for one or more of print jobs completed within a predetermined time.

A printer driver in the sixth embodiment is basically the same in structure as the printer driver 24 described in the first embodiment (see FIG. 5).

The difference between these two drivers is the image forming information obtaining unit and the display management control unit. In the sixth embodiment, when the image forming information received from the MFP is job completion information, it is the image forming information obtaining unit that enters the job completion information into the display management table. In contrast, in the first embodiment, it is the display management control unit that enters the received job completion information into the display management table. In addition, in the sixth embodiment, the display management control unit is designed to instruct the monitor display unit 32, every time a predetermined time has passed, to perform a job completion display for the jobs entered in the display management table in the corresponding time interval.

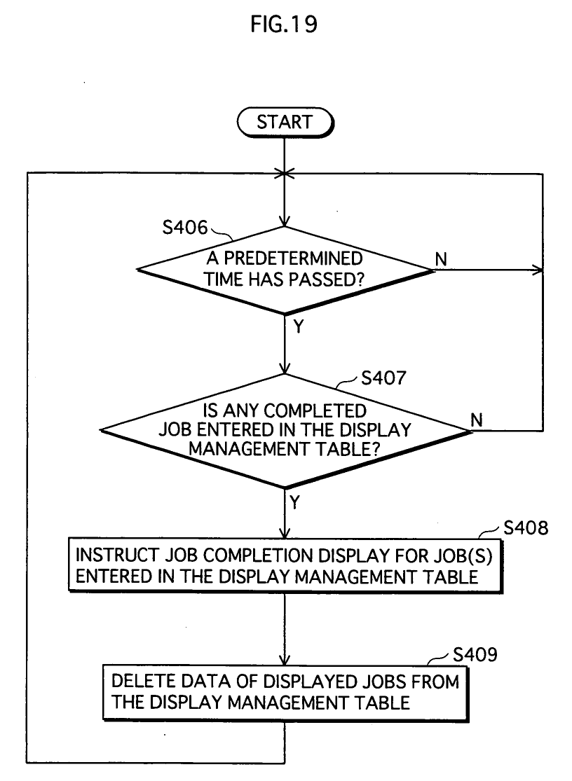

FIG. 19 is a diagram showing a flowchart regarding a display management control unit relating to the sixth embodiment.

Here, the display management control unit first judges whether a predetermined time (e.g. 5 minutes) has passed (Step S406). When the judgment is in the affirmative (Step S406:Y), it is then judged whether any completed job is entered in the display management table (Step S407).

When the judgment in Step S407 is in the affirmative (Step S407:Y), the monitor display unit 32 is instructed to perform a job completion display for the entered print jobs (Step S408), and the data regarding the already displayed print jobs is deleted from the display management table (Step S409), and the control returns to Step S406.

Note that in the above-description, a predetermined time is used as a predetermined condition. However, other conditions are also possible. For example, a job completion display may be collectively performed when a predetermined number of completed jobs are entered in the display management table.

<Summary>

So far, the present invention has been described by way of the embodiments and the modification examples. However, it is needless to say that the present invention is not limited to the concrete examples stated in the embodiments and the modification examples. For example, the following modification examples are also possible.

1. Print Job

(1) Deletion of Print Job (Job Cancellation)

In each of the above-stated embodiments, once the client terminal 10 transmits a print job to the MFP 50, the print job is executed in the image forming apparatus (MFP) without fail (the job having caused an error is also considered to be eventually executed). However, there is practically a case where a user of the client terminal 10 deletes (cancels) a print job after the print job has been transmitted from the client terminal 10.

A printer driver that can deal with such a case (deletion of a print job after being transmitted to the MFP 50) is described as follows as a second modification example.

The printer driver of the second modification example is equipped with a job deletion unit, in addition to the structure of the printer driver of the first embodiment (see FIG. 5). This job deletion unit is designed to instruct the MFP 50 not to execute a print job, upon reception of a deletion instruction of the print job from the user of the client terminal. Here, the deletion instruction is concretely an instruction not to execute the print job.

Next, the processing performed by the job deletion unit is described.

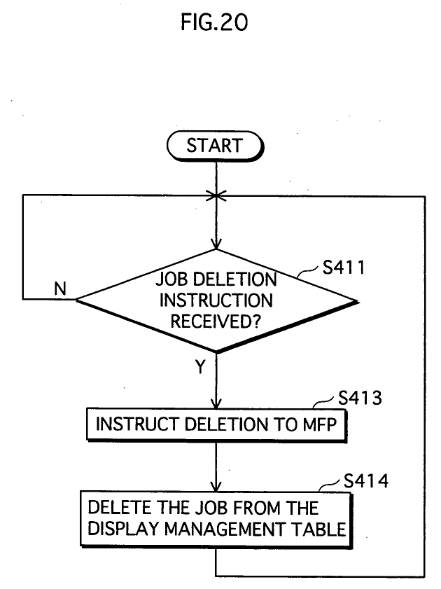

FIG. 20 is a diagram showing a flowchart regarding a job deletion unit relating to the second modification example.

As shown in FIG. 20, the job deletion unit judges, in Step S411, there is an instruction from a user of the client terminal 10 to delete an already transmitted print job. When the judgment is in the negative, the judgment is repeated until it results in the affirmative.

When the judgment in Step S411 results in the affirmative (Step S411:Y), the control proceeds to Step S413, where the deletion instruction of the corresponding print job is given to the MFP 50. In Step S414, the corresponding print job is deleted from the display management table. Then the control returns to Step S411.

Specifically, if the display management table manages the number of transmitted jobs and the number of completed jobs, for the purpose of comparing them (e.g. the display management table T1 in FIG. 5 for the first embodiment), the number of deleted print jobs is subtracted from the number of transmitted jobs in the table.

Meanwhile, if the display management table manages the transmitted print jobs using job ID (e.g. the display management table in FIG. 12 for the second embodiment), the following processing may be performed as an example. That is, deletion of data regarding the job ID corresponding to the print job to be deleted is performed. After this, when there is any job ID entry below this job ID, the print ID(s) will be respectively moved up in the table.

(2) Specific Job

In each of the above-described embodiments, a type of print job transmitted from the client terminal 10 to the MFP 50 is not particularly described. However, there is a type of print job that is to be temporarily stored in a storage unit (memory or HDD) and to be printed out incident to execution of certain processing.

An example of such a type of job (specific job) is a job relating to a highly confidential document. In one procedure relating to a highly confidential document, the print job is stored temporarily in the storage unit, and the actual printing processing is designed to start after the user himself (or his representative) has arrived at the MFP 50 and operated the operation panel unit 50 for example.

The processing of a printer driver that can deal with such a specific job is described as follows as a third modification example.

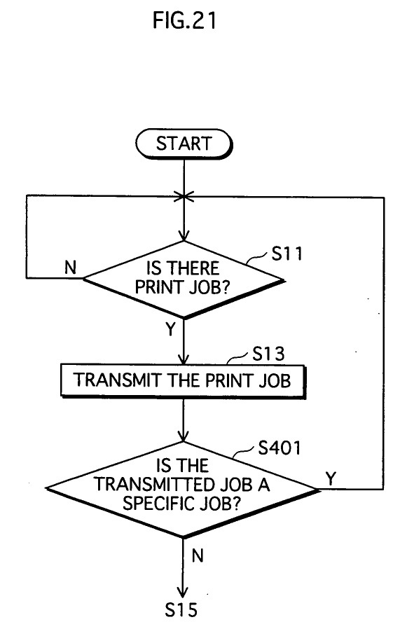

FIG. 21 is a diagram showing a flowchart regarding a job transmission unit relating to the third modification example.

The job transmission unit shown in this drawing is basically the same as the job transmission unit shown in FIG. 7. Therefore the steps for performing the same contents as those in FIG. 7 are assigned the same step numbers as in FIG. 7.

As shown in FIG. 21, the job transmission unit first judges whether there is a print job (Step S11). When the judgment is in the affirmative, the print job is transmitted to the MFP 50 (Step S13). Then it is judged whether the transmitted print job is a specific job (Step S401).

When the print job is judged to be a specific job in Step S401, because a job completion display is not necessary for the specific job, the control returns to Step 11 without entering the specific job to the display management table. Note that the judgment in Step S401 is in the negative, the processing corresponding to Step S15 and Step S17 (see FIG. 7) is performed, and then the control returns to Step S11.

2. Number of Imaging Forming Unit

In all the first to sixth embodiments and the first to third modification examples, the printing system is provided with one image forming unit (MFP 50). However, the number of image forming units in the printing system is not limited to one in the present invention, and it may be a plural.

The following describes a case of using a plurality of MFPs in the printing system, as a fourth modification example.

(1) System Structure

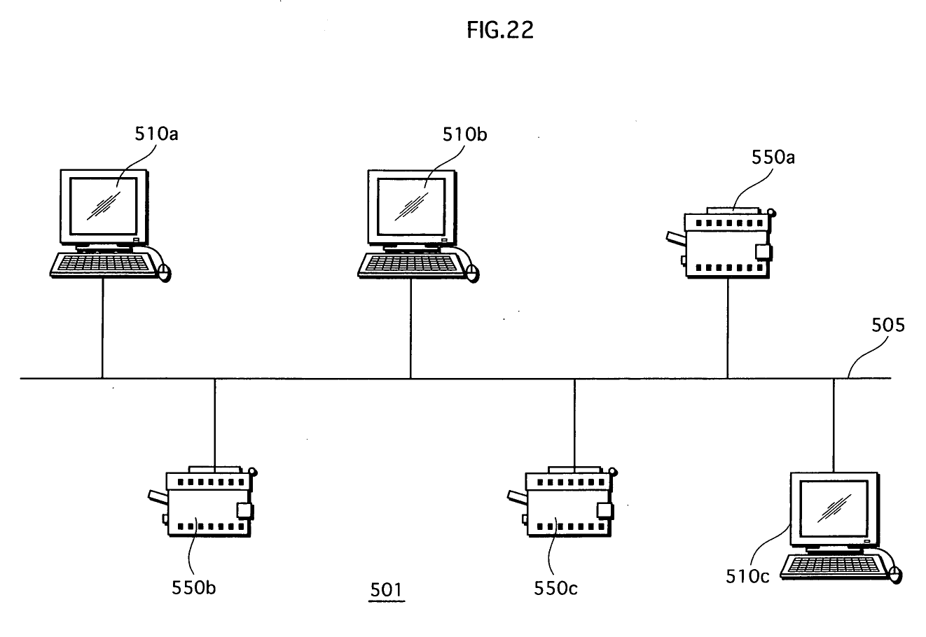

FIG. 22 is a diagram showing an entire structure of a printing system relating to the fourth modification example.

As shown in FIG. 22, in a printing system 501, client terminals 510a, 510b, 510c, and MFPs 550a, 550b, 550c are connected to each other via a network (LAN 505).

Note that the three client terminals are basically the same in structure and the like, and so are collectively referred to as “client terminal 510” in the following explanation. On the other hand, it is necessary to make a distinction among the MFPs, because the client terminal 510 transmits a print job to each MFP. Therefore, the MFPs are respectively referred to as a MFP 550a, a MFP 550b, and a MFP 550c. In case where it is not necessary to distinguish therebetween, the MFPs are collectively referred to as “MFP 550”.

When a client terminal 510 issues print jobs to the MFPs 550a, 550b, and 550c, the printer driver manages print jobs for each of the MFP 550s, and performs a job completion display for print jobs issued to the same MFP 550.

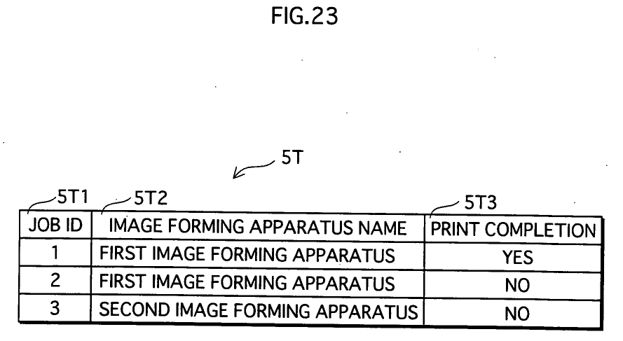

FIG. 23 is a diagram showing a display management table relating to the fourth modification example.

As shown in FIG. 23, the display management table 5T has three columns: “job ID” column 5T1; “image forming apparatus name” column” 5T2; and “print completion” column 5T3. Note that the “job ID” column 5T1 and the “print completion” column 5T3 are the same as their counterparts of the fifth embodiment.

The job transmission unit, either when or after transmitting a print job to an image forming apparatus, for example, enters the name of the image forming apparatus in the “image forming apparatus name” column 5T2, with the latest job ID (the row corresponding to this job ID becomes the bottom row in the display management table 5T). In this example, a name is used to identify an image forming apparatus, but the identifier is not limited to such, and may be an IP address, for example.

Note that in FIG. 23, the display management table 5T shows that print jobs are issued to the first image forming apparatus and the second image forming apparatus, and that the print job for the job ID “1” is complete, whereas the print jobs for the job IDs “2” and “3” are not complete yet.

(2) Processing

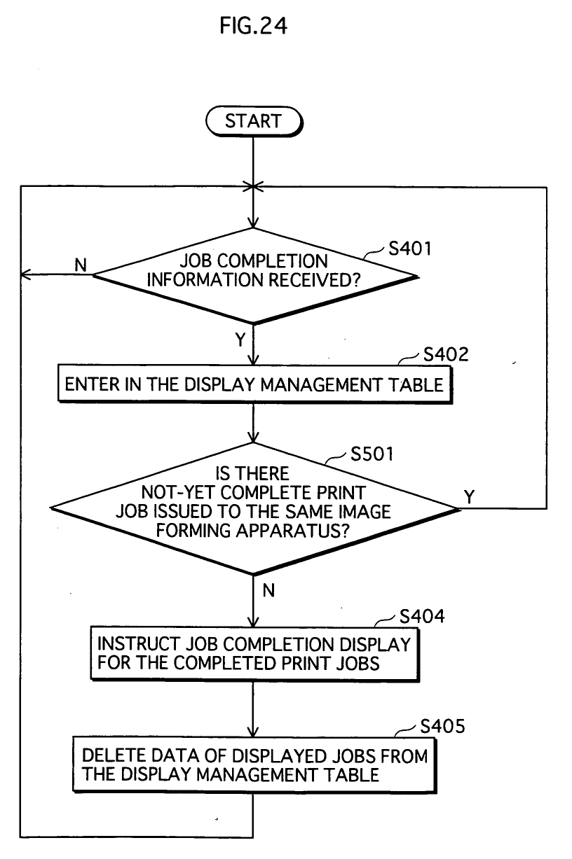

FIG. 24 is a diagram showing a flowchart regarding a display management control unit relating to the fourth modification example.

Upon receiving job completion information from the image forming information obtaining unit (Step S401:Y), the display management control unit enters “Yes” in the “print completion” column 5T3 corresponding to the top print job among the print jobs whose processing has not been completed yet in the display management table 5T (Step S402).

Next, in Step S501, it is judged whether there is any not-yet complete print job issued to the same image forming apparatus by referring to the display management table 5T. When the judgment is in the affirmative (Step S501:Y), the control returns to Step S401 to wait for the completion of the print job, so that a job completion display is collectively performed for the print jobs issued to the same image forming apparatus.

When the judgment is in the negative in Step S501 (Step S501:N), the monitor display unit is instructed to perform a job completion display for the completed print jobs issued to the image forming apparatus (Step S404). Then the data regarding the already displayed print jobs is deleted from the display management table 5T (Step S405). Note that in Step S405, the corresponding data in the “image forming apparatus name” column 5T2 and the “print completion” column 5T3 is deleted.

Note that the example of printing system is one example, and so the number of client terminals and MFPs is not limited to as shown in this example.

3. Job Completion Display

In the above description, a job completion display is not detailed. In principle, the job completion display may be in any form and contents, as long as it indicates completion of a corresponding print job. However if a job completion display involves a plurality of print jobs, it is preferable to distinguish between the print jobs.

So as to realize a display that can distinguish between print jobs, the following may be used as an identifier of a print job: a name of a folder in which data of a requested print job is stored; a time at which a print request is performed; a file name of a requested print job; a serial number of a requested print job. A structure is also possible in which a user inputs a job name, and the job name is used in the display to identify the job.

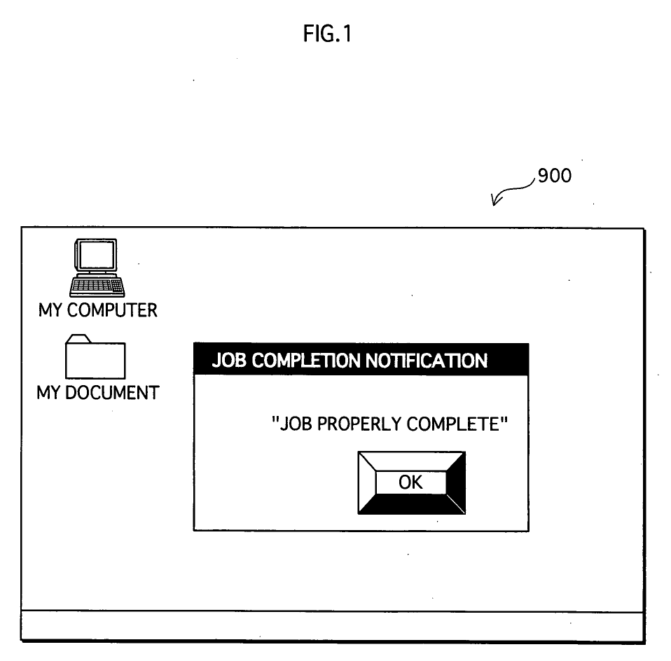

Furthermore, the above description adopts a job completion display 900 as shown in FIG. 1, for notifying a user of a print job completion. However, a user may be notified of a print job completion by other means, such as warning sound and voice.

In using a monitor display to inform a user of a print job completion, information such as “job properly complete” may suffice. This helps reduce the size of the job completion display on the monitor. Needless to say, it is also possible to display other information such as the result of printing, the number of remaining print jobs unexecuted yet, and an operational state of the image forming apparatus.

4. Printing System

In the above description, the printing system is explained to include at least one image forming apparatus and at least one client terminal, where a printer driver is installed in each client terminal.

However, the same advantage as in the printing system of the embodiments is obtained if a printing system includes, outside its client terminal, an apparatus having the same function as that of the printer driver of the present invention.

For example, suppose a printing system in which a client terminal, an image forming apparatus, and a printer server are connected via a network, where the printer server has the same function as that of the printer driver of the embodiments.

In other words, such a printing system has a printer server (a relay unit), an image forming apparatus (an image forming apparatus), and a client terminal (a job reception unit), the client terminal transmitting a print job for image forming in accordance with a user's request to the image forming apparatus via the printer server, the image forming apparatus executing the print job, and upon completion of the print job, transmitting completion information regarding job completion of the print job to the printer server, the printer server transmitting completion-information related information relating to the completion information to the client terminal, and the client terminal reporting completion of the print job to the user by means of a notification, upon receiving the completion-information related information from the printer server, where the printer server includes: a halting unit for, when a predetermined print-job related condition is satisfied, creating a halt state in which any transmission of completion-information related information is halted; and a transmission unit for, upon cancellation of the halt state, transmitting all pieces of completion-information related information whose transmission has been halted in the halt state, in a form organized into a lesser number of groups than a number of the pieces of completion-information related information.

Note that if the relay unit is assumed to be the printer driver of the embodiments and their modification examples described above, a client terminal in the printing system of the embodiments and their modification examples is an apparatus into which a relay unit and a client terminal are integrated.

5. Predetermined Condition

In the above description, creation of a halt state in which completion reporting is halted is performed by using the number of transmitted jobs as a reference. For example in the first embodiment, a halt state is created when the number of transmitted jobs does not match the number of completed jobs (Step S24:N in FIG. 8).

However, other conditions than already stated conditions may also be used in creating a halt state. One of such conditions is that the number of completed print jobs (not yet reported to the user) has not yet reached a predetermined number, regardless of the number of transmitted jobs to the image forming apparatus. In this case, the halt state is cancelled when the number of completed jobs, unreported, has reached the predetermined number.

In realization of this structure, it is possible to include, in a print job, continuation information indicating whether a print request will continue after the print job, and to have a judgment unit to judge that there are continuous print jobs (i.e. meaning that a predetermined condition is satisfied), by referring to the continuation information, so as to efficiently create a halt state in which completion reporting is halted.

6. Cancellation of Halt State

In the above description, completion reporting is performed before the regular cancellation of the halt state, in case the second predetermined condition is satisfied, where the second predetermined condition is different from the predetermined condition under which the halt state is created, and examples of the second predetermined condition include the time, the number of jobs, and conditions relating to the processing. However, these second predetermined conditions may be respectively used as a condition for the regular cancellation of the halt state.

In addition, in the first embodiment, the condition for halting completion reporting to a user matches a condition for cancellation of the halt state (i.e. whether the number of transmitted jobs matches the number of completed jobs). However, these conditions do not have to match, or they do not have to be related to each other.

7. Others

All the embodiments are directed to a client terminal. However, a printer driver program operable to have a client terminal execute such operations as described in the embodiments can be stored in a readable recording medium to be distributed for dealings.

In addition, the program may be distributed via a network and the like for dealings. The program may also be installed in a client terminal via the network. Furthermore, the program may be presented to a user by being displayed on a display apparatus, or by being printed in printed form.

Here, examples of the readable recording medium are: a removable recording medium such as a floppy disk, a CD, an MO, a DVD, and a memory card; and a fixed recording medium such as a hard disk and a semiconductor memory. However, the readable recording medium is not particularly limited to the mentioned concrete examples.

8. Final Note

In the above description, the relationship among each of the embodiments and the modification examples is not particularly explained. However, each of the embodiments and the modification examples and the other notes may be combined as appropriate.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A printing system comprising an image forming apparatus and a client terminal, the image forming apparatus executing a print job for image forming that the client terminal has transmitted in accordance with a user's request and transmitting completion information regarding job completion of the print job to the client terminal upon completion of the print job, and the client terminal reporting completion of the print job to the user by means of a notification, upon receiving the completion information from the image forming apparatus, wherein
the client terminal includes:
a halting unit for, when a predetermined print-job related condition is satisfied, creating a halt state in which any completion reporting is halted; and
a reporting unit for, upon cancellation of the halt state, reporting completion of all print jobs whose completion reporting has been halted in the halt state, by means of a lesser number of notifications than a total number of the print jobs.

2. The printing system of claim 1, wherein
the client terminal includes:
a judgment unit for judging whether the predetermined print-job related condition is satisfied; and
a cancellation judgment unit for judging whether the halt state has been cancelled,
the judgment unit judges that the predetermined print-job related condition is satisfied when a number of transmitted print jobs to the image forming apparatus does not match a number of completed print jobs counted based on completion information received from the image forming apparatus, and
the cancellation judgment unit judges that the halt state has been cancelled when the number of transmitted print jobs matches the number of completed print jobs.

3. The printing system of claim 2, wherein
the judgment unit and the cancellation judgment unit perform judgment with respect to print jobs sharing common information.

4. The printing system of claim 3, wherein
the common information is storage information relating to data storage regarding the print jobs.

5. The printing system of claim 3, wherein
the common information relates to an application on which the print jobs are created.

6. The printing system of claim 3, wherein
the common information is a keyword assigned by the user.

7. The printing system of claim 3, further comprising:
one or more image forming apparatuses that are identical in structure to the image forming apparatus, wherein
the common information identifies a corresponding image forming apparatus to which the print jobs are issued.

8. The printing system of claim 1, wherein
the reporting unit performs the halted completion reporting to the user before the cancellation of the halt state, if a different predetermined print-job related condition from the predetermined print-job related condition is satisfied during the halt state.

9. The printing system of claim 1, wherein
the reporting unit performs the halted completion reporting to the user before the cancellation of the halt state, if during the halt state a predetermined time has passed after transmission of a print job transmitted the last of all the print jobs.

10. The printing system of claim 1, wherein
the client terminal includes an estimation unit for estimating a time required for executing a print job in/after transmitting the print job to the image forming apparatus, and
the reporting unit performs completion reporting to the user before the cancellation of the halt state, if the estimated execution time is a predetermined length or longer.

11. The printing system of claim 1, wherein
the image forming apparatus transmits, to the client terminal, image forming information relating to execution of the print jobs, and
the reporting unit performs completion reporting to the user before the cancellation of the halt state, if the image forming information is predetermined information.

12. The printing system of claim 11, wherein
the predetermined information indicates an printing error occurred in execution of the print jobs.

13. The printing system of claim 1, wherein
the reporting unit performs the halted completion reporting to the user before the cancellation of the halt state, if the number of completed print jobs has reached a predetermined number, where the number of completed print jobs has been judged based on completion information received from the image forming apparatus.

14. The printing system of claim 1, wherein
the reporting unit, if the image forming apparatus has performed predetermined processing during the halt state, performs the following to the user before the cancellation of the halt state: completion reporting; and reporting that the predetermined processing has been performed.

15. The printing system of claim 14, wherein
the predetermined processing is executing of a print job in setting different from setting instructed with respect to the print job.

16. The printing system of claim 2, wherein
the client terminal includes a counting unit for counting the number of transmitted print jobs, and
when an instruction not to perform a print job already transmitted to the image forming apparatus is received, the counting unit subtracts one from the number of transmitted print jobs.

17. The printing system of claim 2, wherein
the client terminal includes a counting unit for counting the number of transmitted print jobs, and
when a print job already transmitted to the image forming apparatus is of a predetermined type, the counting unit subtracts one from the number of transmitted print jobs.

18. A printing system comprising a relay unit, an image forming unit, and a job reception unit, the job reception unit transmitting a print job for image forming in accordance with a user's request to the image forming unit via the relay unit, the image forming unit executing the print job, and upon completion of the print job, transmitting completion information regarding job completion of the print job to the relay unit, the relay unit transmitting completion-information related information relating to the completion information to the job reception unit, and the job reception unit reporting completion of the print job to the user by means of a notification, upon receiving the completion-information related information from the relay unit, wherein
the relay unit includes:
a halting unit for, when a predetermined print-job related condition is satisfied, creating a halt state in which any transmission of completion-information related information is halted; and
a transmission unit for, upon cancellation of the halt state, transmitting all pieces of completion-information related information whose transmission has been halted in the halt state, in a form organized into a lesser number of groups than a number of the pieces of completion-information related information.

19. A recording medium storing therein a printer driver program that is to be installed in a client terminal and is to be connected to an image forming apparatus, the image forming apparatus executing a print job for image forming that the client terminal has transmitted in accordance with a user's request and transmitting completion information regarding job completion of the print job to the client terminal upon completion of the print job, and the client terminal reporting completion of the print job to the user by means of a notification, upon receiving the completion information from the image forming apparatus, the printer driver program have the client terminal perform the following:
halting processing of, when a predetermined print-job related condition is satisfied, creating a halt state in which any completion reporting is halted; and
reporting processing of, upon cancellation of the halt state, reporting completion of all print jobs whose completion reporting has been halted in the halt state, by means of a lesser number of notifications than a total number of the print jobs.

20. The recording medium of claim 19, wherein
the printer driver program further has the client terminal perform the halted completion reporting to the user before the cancellation of the halt state, if during the halt state a predetermined time has passed after transmission of a print job transmitted the last of all the print jobs.
